(19) United States
(12) Patent Application Publication
(10) Pub. No.: US 2009/0165574 A1
(43) Pub. Date: Jul. 2, 2009

(54) INSTRUMENT AND METHOD FOR NUCLEIC ACID AMPLIFICATION

(75) Inventors: David A. COHEN, Dedham, MA (US); Michael J. Mortillaro, Webster, NY (US); Charles Patrick Andre, San Francisco, CA (US)

Correspondence Address: BIRCH STEWART KOLASCH & BIRCH, PO BOX 747, FALLS CHURCH, VA, 22040-0747, US

(73) Assignee: FINNZYMES INSTRUMENTS OY, Espoo (FI)

(21) Appl. No.: 11/965,660

(22) Filed: Dec. 27, 2007

(51) Int. Cl. G01N 1/22

(52) U.S. Cl. 73/863.11

(57) ABSTRACT

The invention relates to a polymerase chain reaction (PCR) process and a thermal cycler. In the process, biological samples are held in a sample carrier having a plurality of sample spaces each having upper and lower ends and the samples are sequentially heated and cooled. The thermal cycler according to the invention comprises heat transfer means for automatic heating and cooling of the samples in the sample carrier, heatable closure means above the upper ends of the samples spaces for preventing condensation of sample vapor during the process, and adjusting means for controlling one process parameter, preferably the temperature of the heatable closure means, depending on at least one other of said process parameters. The invention helps to decrease the number of failed PCR experiments, in particular due to changes in sample volume.

The invention relates to thermal cycler instruments for performing nucleic acid amplification by the polymerase chain reaction (PCR) process. Such instrument comprise heat transfer means for automatic heating and cooling of the samples contained in a sample carrier which is placed within the instrument, and heatable closure means above the upper ends of the samples spaces for preventing condensation of sample vapor during the process. The invention also concerns a related method.

Thermal cyclers are used for amplifying nucleic acids contained in sample tubes (or wells) of microtiter plates or the like by subjecting the sample tubes of the plate containing biolocical reaction mixture to a rapid temperature cycling protocol. For that purpose, microtiter plates are placed on a thermal block which is thermally coupled with a peltier element or some other element suitable for thermal pumping. As the samples typically do not completely fill the tubes and the temperature of the samples is increased to 70° C. and more, considerable evaporation of the sample takes place.

Heated lids which can be introduced on top of the sample plate once the plate is in place on the thermal block were introduced into thermal cyclers to help prevent condensation forming within the tube. Previously, an oil overlay had been used to effectively prevent the water vapor from condensing on the inner walls of the tube that protruded above the heated sample block, and thus, were cooler and prone to condensation build-up. Such condensation could potentially introduce a negative effect on the biological reaction, by effectively raising the concentration of the reactants at the bottom of the tube to the point were the reaction might fail, or introduce spurious results.

Thermal cyclers and vessels for PCR have traditionally been designed such that the tubes have a high profile, whereby adequate gap is left between the top surface of the biological sample and the lower surface of the heated lid. Moreover, the top surface of the biological sample was often maintained below the level of the sample block. In such designs, the level of lid temperature variability allowed was often effective over a broad range of quite high temperatures, typically between 95° C. and 115° C.

Recent developments in the art of thermal cyclers and reaction vessels have lead to reduction of sample volumes and lowering of the tube profiles. However, also unexpected and previously undescribed deterioration of measurement results have been observed due to this new course of design.

It is an aim of the invention to provide a novel and more robust thermal cycler design, in particular for low volume (0.01-50 ul/tube, typically <20 ul/tube, in particular 1-10 ul/tube) PCR studies.

It is also an aim of the invention to provide a PCR method which improves robustness of PCR amplification reactions performed in thermal cyclers.

The invention is based on the finding that the heat provided by the heated lid not only prevents evaporation but also has a significant effect on the course of the reaction through its contribution to the temperature of the sample. The invention provides a solution in which the temperature of the heated lid is adjusted individually for the process currently run with the device, depending on the process conditions. This is in contrast with the established practice, according to which the heated lid temperature has been maintained at a predefined “instrument-specific” temperature independent of prevailing process parameters. Surprisingly it has been found that even a relatively small change in the lid temperature may have a vast improving effect on the efficiency of the reactions.

The thermal cycling instrument according to the invention is intended for carrying out polymerase chain reaction (PCR) process in biological samples under predefined process parameters, the biological samples being held in a sample carrier having a plurality of sample spaces having an open upper end. Therefore, the instrument comprises heat transfer means for automatic heating and cooling of the samples in the sample carrier and heatable closure means, such as a lid platen, above the upper ends of the samples spaces for preventing condensation of sample vapor during the process. Further, there are provided means for adjusting the temperature of the heatable closure means depending on at least one of said process parameters.

The process parameters referred to above may comprise one or more of the following: amount of sample in the sample spaces, temperature cycling protocol used, type of the sample carrier, type of the heat transfer means, type of sealer used for sealing the upper ends of the sample spaces, type of enzyme. Apart from the type of the enzyme, all parameters listed may be considered to affect the sample temperature during the process.

According to a preferred embodiment, one of the process parameters taken into account when adjusting the lid temperature is the amount of sample in the sample spaces. Further, the instrument may be adapted to set the temperature of the heatable closure means lower for a first amount of sample than for a second amount of sample when the first amount of sample is higher than a second amount of sample. Thus, the closer the surface level of the sample is to the heated lid, the lower the temperature of the lid.

In the method according to the invention biological samples are treated under predefined process parameters according to the PCR process, the biological samples being held in a sample carrier having a plurality of sample spaces having an open upper end. The method comprises sequentially heating and cooling the samples in the sample carrier while preventing condensation of sample vapor within the sample spaces during the process by providing heat to the upper ends of the samples, the amount of heat being determined based on at least one of said process parameters.

Thinking in a more general level, the present invention offers a method for performing PCR reactions, in which a change in any one or more of the process parameter(s) can be compensated by adjusting one or more of the other process parameters in order to avoid undesired effects of the change, such as reducing the yield of product from the nucleic amplification. In this generic model the temperature of the lid can be also counted in as a process parameter (either a passive (untouched) parameter, parameter to be compensated or a compensating parameter). In addition to the temperature of the lid, all the parameters listed above and also other parameters contributing to the temperature of the sample, are within the model. However, due to its efficiency and industrial applicability, the lid temperature is in this document frequently described as the (or one of the) compensating parameter (parameters).

The invention allows, for example, any of the following relationships to be taken into account in order to get the desired result of the PCR process (typically the highest possible yield):
dependence of the temperature of the sample on the sample volume by adjusting the temperature of the heated lid (increasing sample volume compensated by decreasing lid temperature and vice versa)
dependence of the temperature of the sample on the type of a sample carrier by adjusting the temperature of the heated lid (higher thermal conductance of the sample carrier compensated by decreasing the lid temperature and vice versa)
dependence of the temperature of the sample on the sealer used by adjusting the temperature of the heated lid (higher thermal conductance of the sealer compensated by decreasing the lid temperature and vice versa).
any combination, aggregation or variation of the above relationships, including substituting any of the parameters listed with the temperature cycling protocol used or type of heat transfer means used.

Further, using the same principle the following relationships can be taken into account:
dependence of the performance of the polymerase enzyme(s) on the temperature of the sample affected by any of the abovementioned interactions,
dependence of the yield of the process on the temperature of the sample affected by any of the abovementioned interactions.

According to one aspect of the invention, there is thus provided an improved process for nucleic acid amplification according to the PCR method performed in a thermal cycling instrument containing a reaction mixture under a number of process parameters, wherein at least one first process parameter is determined before starting the thermal cycling using at least one second process parameter, whereby at least one of said first/second process parameter is a process parameter having an effect on the temperature of the reaction mixture.

According to a further aspect of the invention, the first process parameter (i.e., the compensating process parameter) is a parameter having an effect on the temperature of the reaction mixture.

According to a further aspect of the invention, the second process parameter (i.e., the compensated process parameter) is a parameter having an effect on the temperature of the reaction mixture.

According to a further aspect of the invention, the first or the second process parameter is a parameter not having an effect on the temperature of the reaction mixture, such as the type of the polymerase enzyme used.

The invention provides significant advantages. When studying low volume PCR reactions, it has been found that even small variations in the thermal distribution within the sample may be critical as concerns the success of the experiment. The invention takes into account changes in the thermal environment that may vary from one measurement to another, therefore improving the predictability and repeatability of the experiments. The idea of building the heated lid (or some other heat-affecting part of the system) as a reaction-balancing thermal element is a solution which is effective and easy to implement to new and existing instrument configurations. Although the present design is of particular importance in high performance, low volume thermal cycling, it provides increased robustness even in the case of larger-volume reactions.

We have been able to carry out some experiments that have failed using prior art techniques, successfully using the present approach. This is evidenced by examples described later in this document. In brief, previously increasing or decreasing of the sample volume from a certain volume has resulted in weak amplification reaction. By using the present invention, this change in volume has been compensated only by adjusting the lid temperature correspondingly. On the other hand, we have found that because of their intrinsic properties (e.g. low processivity), most enzymes used in PCR are susceptible to the temperature and thermal irregularities within the sample. This problem can also be solved using the present invention. Also the type of microtiter plate has been demonstrated to be a parameter, which can be taken into account by the present approach. That is, the invention improves the reactions with respect to a very broad range of variables.

According to a preferred embodiment, the temperature of the heated lid for a forthcoming amplification process is determined by a mathematical algorithm implemented into the hardware or software of the thermal cycler. The algorithm is designed such that temperature of the heated lid is optimized for the volume of the reaction and, optionally the type of vessel system used and/or other parameters, taking into account both the detrimental effect of sample evaporation and effects of heat transfer from lid to the sample. For optimal performance, a balance between these phenomena has to be found. In practice, achieving the balance usually requires that the condensation-preventing effect of the heated lid is slightly compromised for the thermal uniformity of the sample.

The sample volume has been found to be the most important factor when determining the lid temperature. This is because the head space, and thus the gap between the top surface of the biological reaction and the lower surface of the heated lid platen have been significantly reduced in recent cycler and vessel designs. The reasons for this reduction in sealed air volume are to minimize the amount of vaporized water within the tube which allows lower sample volumes to be used, and also, the potential for condensation to accumulate along the inner walls of the tube for very low volume reactions. More specifically, the problem caused by such a design is that the heat contributed from the heated lid to the biological sample is transferred at a variable rate dependent upon the volume of the reactions, and thus the over distance between the top of the biological sample and the lower surface of the heated lid. Heat transfer appears to be both of a radiant as well as a conductive forms, such the material and geometry of the reaction plate also plays a contributory role in this heat transfer. Depending upon the volume of the reaction, the material of the tube and sealer, and the sample holder type of the thermal cycler, enough heat may be transferred to the sample, to cause changes of up to 5° C. in bulk sample temperature, as compared with expected results.

For a 96-well slide-sized (about ¼ of an SBS standard sized microtiter plate) microtiter plate, compatible with the Finnzymes Instruments Piko™ thermal cycler, the gap for 25 ul reaction volume is about 5.7 mm, for 10 ul reaction volume about 8.0 mm and for 1 ul reaction volume about 10.6 mm. Thus, it can be seen that the relative distance variation between the surface level of the sample and the heated lid is significant.

Moreover, the pattern of heat in the samples is such that a vertical gradient of temperature is caused within the sample of each tube. For high heated lid temperatures (in this case over 90° C.) this makes obtaining thermal data from the sample very difficult and prone to large errors. These measurement errors within the sample are predominantly caused by limits in the design of measurement instrumentation, such that minute changes in thermal probe placement of as little as 1 mm can cause significant changes in measured temperature of the sample. In addition, for samples with large vertical thermal gradients, using the optimum bulk sample temperature does not guarantee success, as the reaction thermally mix very little during typical cycling protocols, and the resulting reaction efficiencies can be less than desired.

To summarize the advantages of the invention, the invention allows minimizing the difference in temperature between the heated lid and the thermal cycler sample block such that a balance is struck between condensation forming on the inside walls of the tube, and contributory heat transfer from the lid to the sample within the tube.

The term “gap”, unless otherwise mentioned or the context suggests, refers to the vertical distance between the top of the sample liquid within the reaction space and the lower surface of the heated platen above the sample liquid. The gap naturally depends on the amount of sample within the sample space. However, due to the shape of the tubes forming the sample spaces, the relationship is usually not linear.

By “low volume reactions”, we mean primarily reactions having a reaction volume less than 20 ul, in particular between 10 nl and 10 ul per tube. Thus, the invention is suitable, in particular, for 384-well standard-sized (SBS) microtiter plates and 96-well microscope slide-sized (about ¼ of standard SBS plate) microtiter plates and more dense plates.

The term “temperature of the sample” and equivalent expressions are used to describe both the overall (mean) temperature of the sample and the non-even temperature distribution possibly present within the sample.

By “types” of the sealer or the sample carrier or the sample block we primarily mean their characteristics relating to heat conductance, in particular material and geometry.

The “adjusting means”, used for setting the temperature of the heatable closure means, may be any kind of suitable control system functionally connected with a heating element of heatable closure means (e.g. a resistor, a peltier element or heating channel thermally connected with the closure means), so as to regulate its temperature responsive to at least one other process parameter. In particular, the adjusting means may be configures so as to keep the temperature of the heatable closure means, and further the sealer of the sample carrier below 94, in particular below 90° C.

Next, the embodiments of the invention are described more closely with reference to the attached drawings.

FIG. 1. illustrates in a side view a microtiter plate whose sample wells are filled with volumes of sample liquid, and a heated lid placed above the plate, and

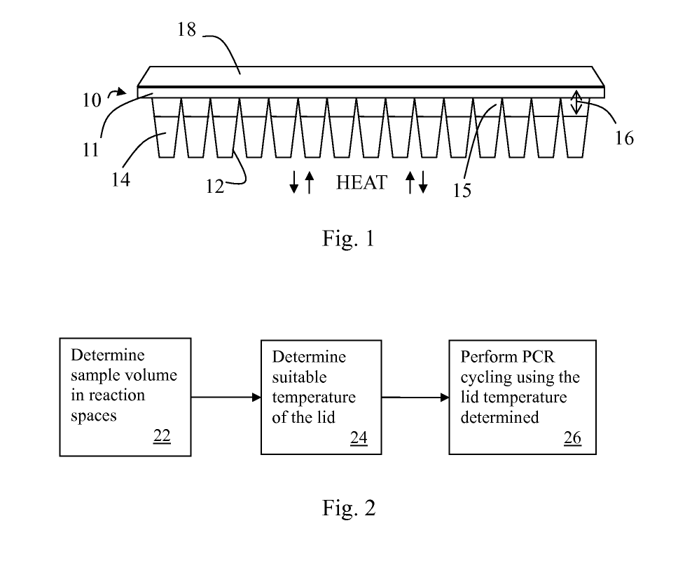

FIG. 2 shows a flow chart of the present method according to one embodiment.

The embodiments described below all relate to polymerase chain reaction (PCR) processes carried out in a thermal cycler. In the process, biological samples are held in a sample carrier, such as a microtiter plate, having a plurality of sample spaces each having upper and lower ends and the samples are sequentially heated and cooled. The thermal cycler comprises heat transfer means for automatic heating and cooling of the samples in the sample carrier, heatable closure means above the upper ends of the samples spaces for preventing condensation of sample vapor during the process. Before starting the cyclic nucleic amplification phase of the process, at least one process parameter, preferably the temperature of the heatable closure means, is adjusted based on at least one other of process parameter. The invention may be used to for decreasing the number of failed PCR experiments, in particular due to changes in sample volume.

FIG. 1 shows a microtiter plate 10 having a deck 11 and a plurality of wells 12. Each of the wells is filled with a certain amount of reaction mixture 14. A heated lid 18 is placed above the deck 11. Thus, a gap 16 is left between the surface of the sample 14 and the heated lid 18. Not only the gap 16, but also a vapor volume 15 is dependent on the amount of the sample 14. Heat is conducted to and from the sample spaces mainly from below, using a heatable and coolable thermal block (not shown), on which the microtiter plate 10 rests in intimately contacts. The thermal block is made from heat-conducting material and is typically attached from its lower surface to a peltier element or the like means for actuating efficient heat transfer. The lower surface of the peltier element is typically in thermal contact with a heat sink. It is primarily this arrangement that is used for controlling the thermal energy of the reaction mixture. However, as the distance 16 is relatively short, also the lid 18 contributes to the total thermal energy of the mixture.

Normally, sealing means, that is, individual sealing caps, cap strips, a cap plate or a planar sealing film or slab, typically of polymer material, are/is placed at the open ends of the reactions spaces above the deck 11 of the plate 10, such that they/it remain(s) between the heated lid 18 and the plate during PCR cycling. Heat is transferred through the sealing means to the reaction space. At the same time, the lid directs to the sealing means and to plate a small force, which ensures proper seating of the plate against the thermal block and tight sealing of the reactions spaces.

FIG. 2 shows the main steps for taking into account the sample volume and thus improving the reaction efficiency. In step 22, the sample volume (or equivalently the surface height or the sample or the gap) is determined automatically by the thermal cycler, e.g. by direct measurement or through a data communication bus contained in the device, or by manually entering the volume data to the instrument. In step 24, the most favourable lid temperature or temperature cycling protocol is determined for the heated lid. Usually, this is carried out by a software-controlled microprocessor contained in the device. Also other process parameters can be taken into account when determining the lid temperature. In step 26, the thermal cycling is performed according to the desired PCR protocol, at the same time controlling the lid temperature as previously calculated.

According to one embodiment, there are provided computing means adapted to run an algorithm for determining the optimal lid temperature and means for automatically adjusting the heated lid temperature based on the output of the algorithm. The algorithm may be built based upon a number of factors, primarily including the block type of the system, the volume of the reaction, the type of vessel, the type of sealer used and the programmed temperature of the protocol. Some of these parameters may be factory-set (and thus integrally implemented to the algorithm as constant factors), while some may be obtained from the user of the instrument through user interface means (as variables). Alternatively, all of these parameters are user-definable. The variables may differ from run-to-run in the same system, and thus the heated lid temperature is preferably reformulated when one or more of these variables are changed.

Using the present approach, the overall temperature of the heated lid for small volume samples can be kept continuously at or below 94° C., in particular at or below 90° C., preferably between 50° C. and 90° C. without compromising the overall performance of the instrument.

The temperature of the heatable closure means may have a linear or roughly linear dependence on the amount of sample. Thus, the temperature may obey the formula T=T₀-aV, where T is the temperature of the heatable closure means, T₀ is a predefined constant temperature, a is a constant and V is the volume of the sample in each of the sample spaces. Linearly implemented dependence has shown to give fairly good results in the usual case where upper portions of tubes are of constant cross-sectional area (e.g. cylindrical or only slightly conical). In such systems, the volume of the sample is directly proportional to its surface level height. Despite the simplicity of this model, it has been proven to be very effective. The invention is, however, not limited to any particular model, because, as understood by a person skilled in the art, other types of temperature adjustment algorithms may be also used. According to an alternative embodiment, the dependence is non-linear.

According to one embodiment, the temperature of the heated lid is varied during the process, depending on the phase of the PCR cycle. Preferably, the lid temperature is controlled in parallel with the temperature of the thermal block, i.e., the lid temperature is decreased when the samples are cooled and increased when the samples are heated.

The heatable closure means, i.e. the lid, preferably comprises a planar plate intimately attachable to the upper ends of the sample spaces so as to cover the whole plate at a time. Between the lid and the vessel, there may be provided additional sealing means, such as tube caps or a polymer film glued or bonded to the vessel, for providing more permanent sealing. Such a seal prevents contamination of the samples also when the vessel is not placed in the cycler and kept under the lid. The thermal properties of the additional sealing means can be used as one of the parameters having an effect on the lid temperature.

The heat transfer means typically comprise a metallic block shaped so as to provide intimate contact with the vessel containing individual tubes as protrusions on the bottom surface thereof. Thus, heat is conducted through the tube bottom (usually U- or V-shaped) and side walls for maximizing the temperature ramping speeds.

According to one embodiment, the instrument comprises user input means for allowing manual inputting of at least one process parameter. The user input means typically comprises a keyboard or a keypad. Alternatively or additionally, there may be provided detection means for automatically determining one or more of the process parameters. The detection means may comprise a sample surface level, volume or mass detector.

According to a preferred embodiment the temperature of the heated lid is chosen so as to reduce the vertical thermal gradient formed within the samples during the process. Thus, average thermal gradient calculated over each PCR temperature cycle is reduced, compared with a constant over 90° C. temperature traditionally used.

According to a preferred embodiment, the temperature of the heated lid is chosen from the range extending from 50° C. to 90° C. or the temperature is varied during the process within that range.

Means for controlling the temperature of the heated lid typically comprises a microprocessor and a program run by the microprocessor. The microprocessor is typically the same which is used for controlling other functions of the instrument, such as implementation of the thermal cycling protocols.

The invention and its various embodiments can be applied to both end-point and real-time PCR apparatuses and processes.

The instrument and its embodiments described above are used for carrying out polymerase chain reaction (PCR) process, such as DNA amplification. The physical specifications of the instrument used, the aim and nature of the experiment in question determine the limits for the reaction parameters, of which one or more may be variable, i.e., freely user-definable. Once the variable parameters are chosen, these are given to the instrument through user interface. The sample carrier loaded with the desired biological reaction mixture(s) is placed on the thermal block of the device and the heated lid is pressed onto the carrier. After that, the PCR process may be begun, one phase of which is frequent heating and cooling of the samples. During this cycling condensation of sample vapor on the walls of the tubes is prevented by providing heat to upper portions of the tubes, i.e., to the inner surfaces of the air space within the tubes. The amount of heat may be determined according to any of the embodiments described above.

### EXAMPLES

The following examples illustrate the significance of the adjustment of lid temperature on the basis of reaction parameters.

### Example 1

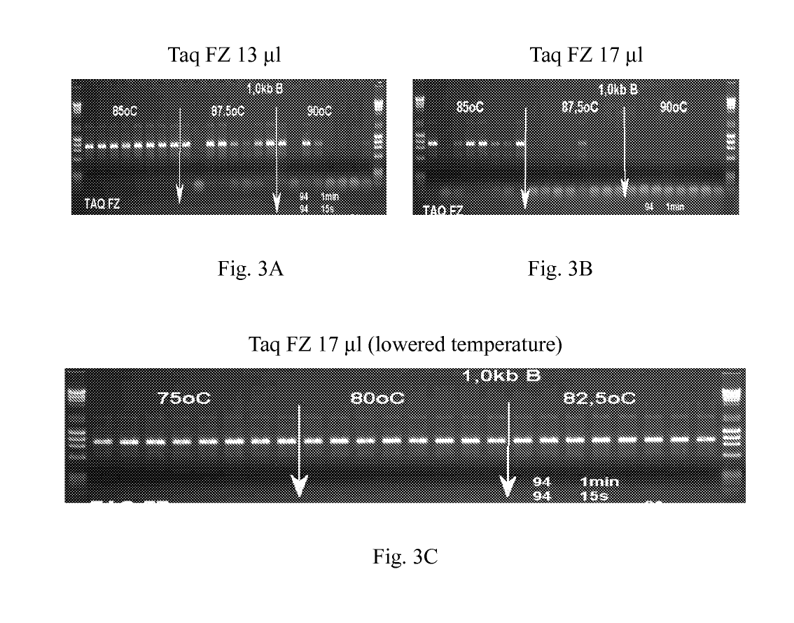

### FIGS. 3A-3C

TAQ FZ With Lid Temperature Modification: (13 vs 17 μl Beta-2-Microglobulin)

A 988 bp human genomic sequence (beta-2-microglobulin) amplicon was amplified in replicate wells of a ultra-thin wall (UTW) vessel using Taq (Finnzymes) DNA polymerase enzyme and a 96-well Piko™ thermal cycler. The lid temperature was set at 85° C., 87.5° C. and 90° C. respectively with 2 different reaction volumes, 13 μl (FIG. 3A) and 17 μl (FIG. 3B). As can be seen from the Figures, with 13 μl, the reaction works well at 85° C. lid temperature. However, there is a vast improvement in the PCR reaction by further lowering the lid temperature setting for the 17 μl reaction (FIG. 3C).

### Example 2

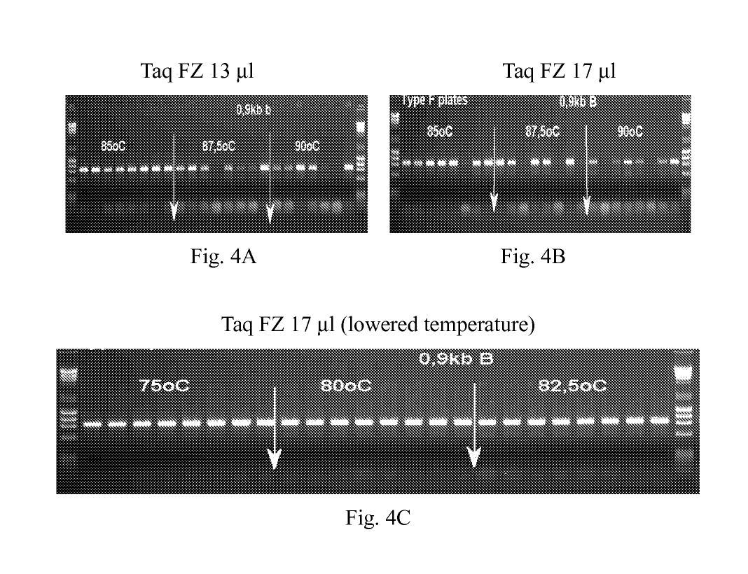

### FIGS. 4A-4C

TAQ FZ With Lid Temperature Modification: (13 vs 17 μl Dihydrofolate Reductase)

A 922 bp human genomic sequence (dihydrofolate reductase) amplicon was amplified in replicate wells of a UTW vessel using Taq (Finnzymes) DNA polymerase enzyme and a 96-well Piko™ thermal cycler. The lid temperature was set at 85° C., 87.5° C. and 90° C. respectively with 2 different reaction volumes, 13 μl (FIG. 4A) and 17 μl (FIG. 4B). Again, with 13 μl, the reaction works well at 85° C. lid temp. The figures show that there is a vast improvement in the PCR reaction by further lowering the lid temperature setting for the 17 μl reaction (FIG. 4C).

### Example 3

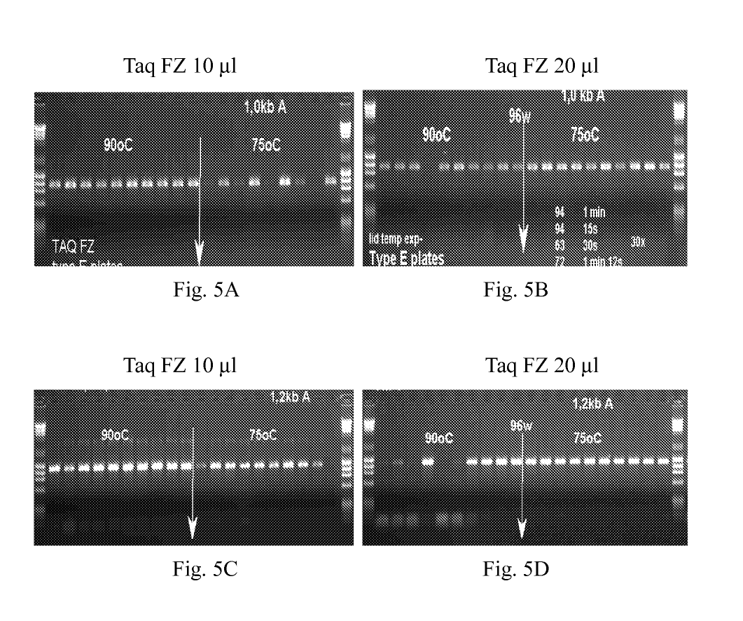

### FIGS. 5A-5D

TAQ FZ With Different Lid Temperature Modification: (10 vs 20 μl Beta-2-Microblobulin and Glutathione Peroxidase 3)

A 1005 bp (beta-2-microblobulin) and a 1217 bp (glutathione peroxidase 3) human genomic sequence amplicons were amplified in replicate wells of a UTW vessel using Taq (Finnzymes) DNA polymerase enzyme and a 96-well Piko™ thermal cycler. The lid temperature was set at 75° C. and 90° C. respectively with 2 different reaction volumes, 10 μl (left, FIGS. 5A and 5C) and 20 μl (right, FIGS. 5B and 5D). Once again, it shows that a lower reaction volume (10 μl) performs much better at a higher lid temperature but with a higher reaction volume (20 μl) lowering the lid temperature improves the PCR performance.

### Example 4

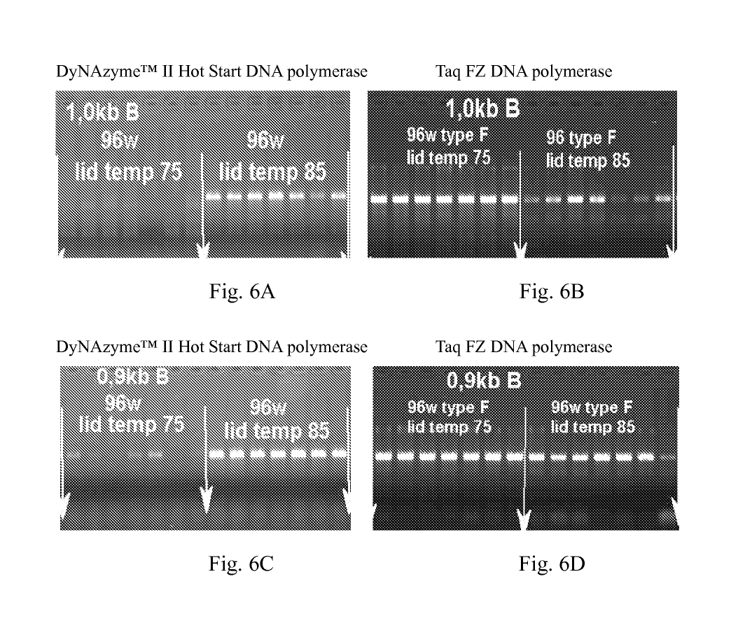

### FIGS. 6A-6D

The Effect of Difference in Lid Temperature on Different DNA Polymerase Enzymes (DyNAzyme™ II Hot Start DNA Polymerase vs Taq Finnzymes)

DyNAzyme™ II Hot Start DNA polymerase and Taq (Finnzymes) DNA polymerase enzymes were used with a 96-well Piko™ thermal cycler to amplify 1.0 and 0.9 kb amplicons at a reaction volume of 20 μl. Both reactions were performed in 96-wellplates. The results show that the amplification reaction works better for DyNAzyme™ enzyme at higher lid temp (85° C.) as opposed to Taq FZ, which works better at lower lid temp (75° C.). This might be due to the fact that DyNAzyme™ is a chemically inactivated polymerase and a preactivation step (95 or 94° C. for 10 min) is essential to activate the polymerase, thus by having too low lid temperature, the sample temperature cannot reach to the stage to activate all the polymerase. On the other hand, FZ Taq (which requires only 1 min preactivation step) works better at lid temp 75° C. during the entire run.

During the experiments, it was observed in practice that the type of the vessel (e.g. its plastic type) had an effect on the experiments. (need some additional comment here?)

Additional information on the reaction parameters used in the Examples:

1217 bp F ctgacccccactatcccttgaca
R cttggactggccctttcttttctt

922 bp F ctttttatatgttactgggcttagg
R aaaaatcgactgcacaatgacg

1005 bp F aggcgcccgctaagttcg
R ctcaagatctctggcgtcctcaa

988 bp F cctgggcaatggaatga
R acttaactatcttgggctgtgac

PCR condition for all Taq FZ reaction (30 cycles):

Taq, 1.0 kb and 0.9 kb amplicons, B:

| | | | |
|---|---|---|---|
| 94° C. | 1 min | | |
| 94° C. | 15 s | | |
| 55° C. | 30 s | | |
| 72° C. | 1 min | 72° C. | 5 min final extension |

Taq, 1.0 kb and 1.2 kb amplicons, A:

| | |
|---|---|
| 94° C. | 1 min |
| 94° C. | 15 s |
| 63° C. | 30 s |
| 72° C. | 1 min 12 s |
| 72° C. | 5 min final extension |

PCR conditions for DyNAzyme™ II Hot Start DNA Polymerase (30 cycles):

| | |
|---|---|
| 94° C. | 10 min |
| 94° C. | 15 s |
| 55° C. | 30 s |
| 72° C. | 1 min per kb |
| 72° C. | 10 min final extension |

1. A thermal cycling instrument for carrying out polymerase chain reaction (PCR) process in biological samples under predefined process parameters, the biological samples being held in a sample carrier having a plurality of sample spaces each having upper and lower ends, the instrument comprising
heat transfer means for automatic heating and cooling of the samples in the sample carrier,
heatable closure means above the upper ends of the samples spaces for preventing condensation of sample vapor during the process, and
adjusting means for controlling the temperature of the heatable closure means depending on at least one of said process parameters.

2. The instrument according to claim 1, wherein said at least one of said process parameters include one or more of the following: amount of sample in the sample spaces, temperature cycling protocol used, type of the sample carrier, type of the heat transfer means, type of sealer used for sealing the upper ends of the sample spaces, type(s) of enzyme(s) contained in the sample spaces.

3. The instrument according to claim 1, wherein said at least one process parameter is the amount of sample in the sample spaces.

4. The instrument according to claim 3, which is adapted to set the temperature of the heatable closure means lower for a first amount of sample than for a second amount of sample when the first amount of sample is higher than a second amount of sample.

5. The instrument according to claim 1, wherein the temperature of the heatable closure means has a linear or roughly linear dependence on the amount of sample.

6. The instrument according to claim 1, wherein the temperature of the heatable closure means has a non-linear dependence on the amount of sample.

7. The instrument according to claim 1, wherein the temperature of the heatable closure means is variable during the process.

8. The instrument according to claim 7, wherein the temperature of the heatable closure means is controlled in parallel with the temperature of the heat transfer means.

9. The instrument according to claim 1, wherein the heatable closure means comprises a planar plate intimately attachable to the upper ends of the sample spaces.

10. The instrument according to claim 1, wherein said heat transfer means comprise a metallic block shaped so as to provide intimate thermal contact with the lower ends of said sample spaces.

11. The instrument according to claim 1, which comprises user input means for allowing manual inputting said at least one process parameter.

12. The instrument according to claim 1, which comprises detection means for automatically determining said at least one process parameter.

13. The instrument according to claim 1, wherein the temperature of the heatable closure means is adapted to reduce the vertical thermal gradient formed within the samples during the process.

14. The instrument according to claim 1, which is adapted to keep the temperature of the heatable closure means during said automatic heating and cooling between 50° C. and 90° C.

15. The instrument according to claim 1, wherein the heat transfer means for automatic heating and cooling of the samples in the sample carrier are adapted to hold sample carriers having reaction spaces having usable reaction volumes of about 0.01-50 ul.

16. A method for carrying out polymerase chain reaction (PCR) process in biological samples under predefined process parameters, the biological samples being held in a sample carrier having a plurality of sample spaces each having upper and lower ends, the method comprising
sequentially heating and cooling the samples in the sample carrier,
preventing condensation of sample vapor within the sample spaces during the process by providing heat to the upper ends of the sample spaces, the amount of heat being determined based on at least one of said process parameters.

17. The method according to claim 16, wherein said process parameters include one or more of the following: amount of sample in the sample spaces, temperature cycling protocol used, type of the sample carrier, type of the heat transfer means, type of sealer used for sealing the upper ends of the sample spaces, type(s) of enzyme(s) contained in the sample spaces.

18. The method according to claim 16, wherein the amount of sample in the sample spaces is used as said at least one process parameter.

19. The method according to claim 18, wherein the temperature of the heatable closure means is set lower for a first amount of sample than for a second amount of sample when the first amount of sample is higher than a second amount of sample.

20. The method according to claim 16, wherein a sample volume of 0.01-50 ul is used, preferably less than 10 ul, in particular 1-10 ul.

21. The method according to claim 16, wherein the samples contain enzyme of standard low processivity, such as Taq or DyNAzyme™.

22. A process for nucleic acid amplification according to the PCR method performed in a thermal cycling instrument containing a reaction mixture under a number of process parameters, wherein at least one first process parameter is determined before starting the thermal cycling using at least one second process parameter, whereby at least one of said first or second process parameter is a process parameter having an effect on the temperature of the reaction mixture during the process.

23. The process according to claim 22, wherein the first process parameter is a process parameter having an effect on the temperature of the reaction mixture during the process.

24. The process according to claim 22, wherein the second process parameter is a process parameter having an effect on the temperature of the reaction mixture during the process.

25. The process according to claims 22, wherein the first or the second process parameter is a process parameter not having an effect on the temperature of the reaction mixture during the process.

26. The process according to claims 22, wherein the process parameters are selected from the group of:
temperature of a heated lid placed above the reaction mixture, amount of reaction mixture, thermal cycling protocol used, type of a sample carrier the reaction mixture is contained in, type of heat transfer means used for actuating the thermal cycling, type of a sealer used for sealing the sample carrier, as being process parameters having an effect on the temperature of the reaction mixture during the process, and
type(s) of enzyme(s) contained in the sample spaces, as being a process parameter not having an effect on the temperature of the reaction mixture during the process.

27. The process according to claim 22, wherein
the first parameter is the temperature of heated lid placed above the reaction mixture and/or type of sample carrier the reaction mixture is contained in and/or the type of sealer used for sealing the sample carrier and/or the polymerase enzyme contained in the reaction mixture, and
the second parameter is the volume of the reaction mixture.

28. The process according to claim 22, wherein
the first parameter is the temperature of a heated lid placed above the reaction mixture and/or type of sealer used for sealing the sample carrier and/or volume of the reaction mixture and/or the polymerase enzyme contained in the reaction mixture, and
the second parameter is the type of a sample carrier the reaction mixture is contained in.

29. The process according to claim 22, wherein
the first parameter is the temperature of the heated lid placed above the reaction mixture and/or the type of the sample carrier the reaction mixture is contained in and/or the volume of the reaction mixture and/or the polymerase enzyme contained in the reaction mixture, and
the second parameter is the type of a sealer used for sealing the sample carrier the reaction mixture is contained in.

30. The process according to claim 22, wherein
the first parameter is the temperature of the heated lid placed above the reaction mixture and/or the type of the sample carrier the reaction mixture is contained in and/or the volume of the reaction mixture and/or the polymerase enzyme contained in the reaction mixture and/or the type of a sealer used for sealing the sample carrier the reaction mixture is contained in, and
the second parameter is the polymerase enzyme contained in the reaction mixture.

31. The process according to claim 22, wherein
the first parameter is the type of the sample carrier the reaction mixture is contained in and/or the volume of the reaction mixture and/or the polymerase enzyme contained in the reaction mixture and/or the type of a sealer used for sealing the sample carrier the reaction mixture is contained in, and the second parameter is the temperature of the heated lid placed above the reaction mixture.
